(19) United States
(12) Patent Application Publication
(10) Pub. No.: US 2025/0240507 A1
(43) Pub. Date: Jul. 24, 2025

(54) RADIATION IMAGING CONTROL APPARATUS AND RADIATION IMAGING SYSTEM

(71) Applicant: CANON KABUSHIKI KAISHA, Tokyo (JP)

(72) Inventor: KEIKO UEHARA, Kanagawa (JP)

(21) Appl. No.: 19/020,826

(22) Filed: Jan. 14, 2025

(30) Foreign Application Priority Data
Jan. 22, 2024 (JP) 2024-007695

(51) Int. Cl. H04N 23/30; H04N 23/10; H04N 23/61; H04N 23/63

(52) U.S. Cl. CPC H04N 23/30; H04N 23/10; H04N 23/61; H04N 23/631

(57) ABSTRACT

A radiation imaging control apparatus includes a memory storing a program and at least one processor, that when executing the program, causes the radiation imaging control apparatus to acquire an optical image, determine, based on the acquired optical image, a preparation status of radiation imaging, and control output of the acquired optical image to a display apparatus. Output of the acquired optical image to the display apparatus is based on a determination result on the preparation of the radiation imaging.

### BACKGROUND

### Field

The present disclosure relates to a control apparatus that controls radiation imaging and a radiation imaging system.

### Description of the Related Art

Radiation imaging apparatuses using a flat panel detector (FPD) made of a semiconductor material are widely used as imaging apparatuses for use in medical imaging diagnosis or non-destructive testing by radiation. In medical imaging diagnosis, for example, such radiation imaging apparatuses are used as digital imaging apparatuses for still image capturing such as general radiography and moving image capturing such as fluoroscopy.

In general, a procedure to align positions of a radiographic tube to emit radiation and of a subject is performed in radiation imaging. Japanese Patent Application Laid-Open No. 2013-48740 discusses guiding means to help positioning of the subject suited for imaging, using a subject image obtained by a camera at the time of radiation imaging. Japanese Patent Application Laid-Open No. 2021-69698 can display a subject image to be positioned during imaging, by performing masking processing thereon while considering patients' privacy.

However, the techniques described in the above-mentioned patent documents have room for improvement in terms of the privacy protection for subjects (examinees) and operability enhancement for operators.

### SUMMARY

An aspect of the present disclosure includes pursuing imaging while better considering privacy and alleviating the time and effort of a technician (operator).

According to an aspect of the present disclosure, a radiation imaging control apparatus includes a memory storing a program and at least one processor, that when executing the program, causes the radiation imaging control apparatus to acquire an optical image, determine, based on the acquired optical image, a preparation status of radiation imaging, and control output of the acquired optical image to a display apparatus, wherein output of the acquired optical image to the display apparatus is based on a determination result on the preparation status of the radiation imaging.

Further features of the present disclosure will become apparent from the following description of exemplary embodiments with reference to the attached drawings.

### BRIEF DESCRIPTION OF THE DRAWINGS

FIG. 1 illustrates an example of a configuration of a radiation imaging system according to a first embodiment.

FIG. 2 illustrates a determination table for imaging preparation completion determination according to the first embodiment.

FIG. 3 is a flowchart illustrating optical image display according to the first embodiment.

FIG. 4 is a flowchart illustrating the imaging preparation completion determination according to the first embodiment.

FIG. 5 illustrates an example of a configuration of a radiation imaging system according to a second embodiment.

FIG. 6 is a flowchart illustrating optical image display according to the second embodiment.

FIG. 7 is a flowchart illustrating optical image re-display according to the second embodiment.

### DESCRIPTION OF THE EMBODIMENTS

Hereinafter, embodiments of the present disclosure will be described with reference to the attached drawings. The following embodiments are not seen to be limiting, and not all of the combinations of features described in the embodiments are essential for the solution provided by the present disclosure.

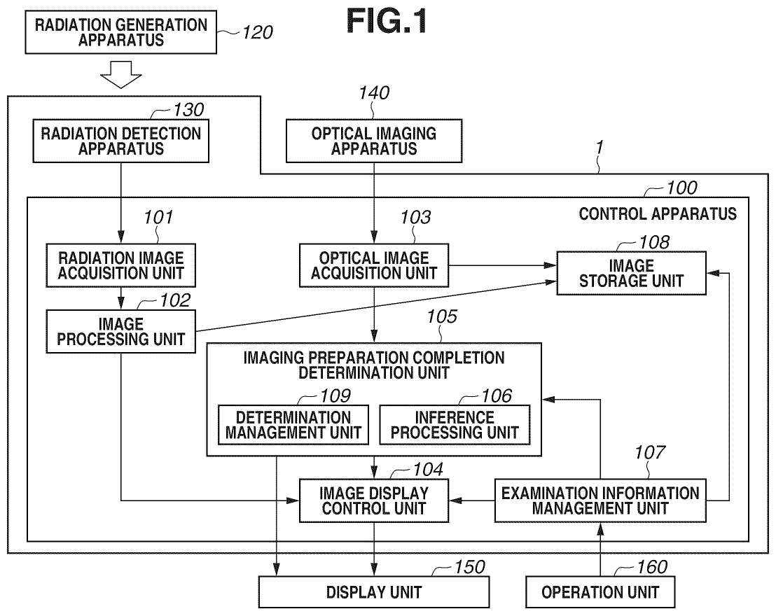

A configuration and an operation of a radiation imaging system according to an embodiment of the present disclosure will be described with reference to FIGS. 1 to 4.

FIG. 1 illustrates an example of a configuration of a radiation imaging system according to a first embodiment. The radiation imaging system 1 includes a control apparatus 100 that controls radiation imaging and a radiation detection apparatus 130. The control apparatus 100 controls radiation imaging using the radiation detection apparatus 130.

In FIG. 1, the radiation generation apparatus 120, an optical imaging apparatus 140, a display unit 150 serving as a display apparatus, and an operation unit 160 are also included. The following describes each configuration.

The radiation detection apparatus 130 detects radiation emitted from the radiation generation apparatus 120 and passed through an examinee (not illustrated), which is a subject, and outputs image data corresponding to the radiation. The image data can also be rephrased as a medical image or a radiation image. To be specific, the radiation detection apparatus 130 detects radiation that has passed through an examinee as a charge that corresponds to a transmitted radiation amount. For example, the radiation detection apparatus 130 uses a direct conversion sensor, such as amorphous selenium (a-Se) that converts radiation into charge, for directly converting radiation into charge, or an indirect conversion sensor that uses a scintillator, such as cesium iodide (CsI), for converting radiation into visible light and a photoelectric conversion element, such as amorphous silicon (a-Si). The radiation detection apparatus 130 also performs A/D conversion on the detected charge to generate image data, and outputs the image data to the control apparatus 100.

The control apparatus 100 serving as a radiation imaging control apparatus is connected to the radiation generation apparatus 120, the radiation detection apparatus 130, and the optical imaging apparatus 140 via, for example, a wired or wireless network or a dedicated line. The control apparatus 100 has an application function that operates on a computer. That is, the control apparatus 100 includes one or more processors and memories, and the one or more processors execute a program stored in a memory to realize functional units described below. However, some or all of the functional units can be realized by dedicated hardware.

The control apparatus 100 controls the timing at which the radiation generation apparatus 120 generates radiation and the imaging conditions for the radiation, based on the examination information received by the operation unit 160. The radiation image acquisition unit 101 controls the timings at which the radiation detection apparatus 130 captures and outputs image data, and receives and acquires the generated image data. The image processing unit 102 performs image processing on the received image data. The image display control unit 104 displays the image-processed image on the display unit 150, which is a display apparatus. The image display control unit 104 provides a graphical user interface using the display unit 150, and receives an instruction from an operator via the operation unit 160. The examination information is selected based on the received input, and the examination information management unit 107 manages the information. The examination information management unit 107 has a function of acquiring a radiation imaging protocol from an external apparatus and managing radiation imaging, based on the information. The examination information management unit 107 can also be hereinafter referred to as a second acquisition unit. The radiation imaging protocol includes various conditions for radiation imaging, and also includes information about a portion of a subject to be imaged.

The control apparatus 100 controls conditions, timing, a frame rate, and the like, under which the optical imaging apparatus 140 acquires an optical image. The optical image acquisition unit 103 acquires an optical image from the optical imaging apparatus 140. This optical image is an optical image related to a subject (examinee). The optical image acquisition unit 103 can also be hereinafter referred to as a first acquisition unit. The image display control unit 104 adds information to be displayed other than the optical image, and controls content to be displayed with the display unit 150 serving as a display apparatus. The image display control unit 104 controls whether to output the optical image acquired by the optical image acquisition unit 103, which is a first acquisition unit, to the display unit 150, which is a display apparatus, based on a determination result of an imaging preparation completion determination unit 105, which will be described below. Thus, the image display control unit 104 can also be hereinafter referred to as a display control unit.

The imaging preparation completion determination unit 105 estimates the preparation status of radiation imaging, based on the optical image acquired from the optical image acquisition unit 103, and determines whether imaging preparation has been completed. Specifically, the imaging preparation completion determination unit 105 uses the optical image acquired from the optical image acquisition unit 103 and the examination information acquired from the examination information management unit 107 to determine the position and the movement of the subject in the optical image and the presence or absence in the optical image other than the subject, and determines whether imaging preparation has been completed. The imaging preparation completion determination unit 105 can also be hereinafter referred to as a determination unit. The “imaging preparation completion” does not refer to, for example, detailed positioning as described in Japanese Patent Application Laid-Open No. 2013-48740, but to completion of work that does not require the optical image, such as installation of the FPD, guidance of the patient to the examination table, and a laboratory-derived work performed by a technician in a laboratory. The imaging preparation completion determination unit 105 can perform determination by using an inference processing unit 106 using machine learning, or the like. As described above, the image display control unit 104 controls whether to output an optical image to the display unit 150, which is a display apparatus, based on the result of the determination.

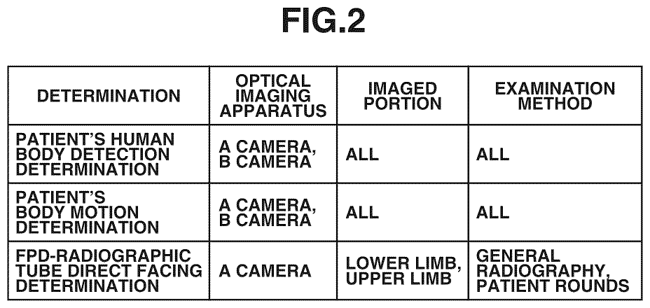

The determination management unit 109 stores determination content and determination conditions, and manages the determination content of the imaging preparation completion determination unit 105. Whether the determination content is performed in each examination is determined by a combination of the optical imaging apparatus 140 and the imaging conditions. The determination management unit 109 can have, for example, a determination table as illustrated in FIG. 2, and performs a determination on an examination that satisfies the condition. Alternatively, a setting unit can be displayed on the display unit 150 so that a user can set which determination is performed in each examination. An image storage unit 108 stores the images acquired by the radiation image acquisition unit 101 or the optical image acquisition unit 103.

The operation unit 160 performs an operation of selecting and setting information to be examined, from a plurality of pieces of examination information. For example, the operation unit 160 is displays a plurality of pieces of examination information acquired by the examination information management unit 107 on the display unit 150 in a list format, receives a user's operational input for selecting one piece of examination information from the list, and sets the selected examination information as an examination target.

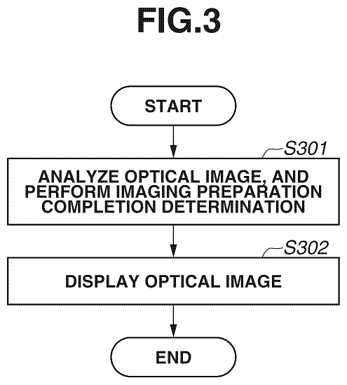

FIG. 3 illustrates a flowchart from the start of an examination to the display of a subject image according to the first embodiment. Here, an example of general radiography of a lower limb will be described.

In step S301, the imaging preparation completion determination unit 105 determines whether the imaging preparation is completed, by using the optical image acquired by the optical image acquisition unit 103. The determination content will be described below. After the completion of the determination, the image display control unit 104 displays the optical image on the display unit 150 in step S302 if the determination result indicates “imaging preparation completion”. If the determination result indicates that the imaging preparation is not completed (“imaging preparation incomplete”), the image display control unit 104 does not display the optical image on the display unit 150. The image display control unit 104 can display immediately after the determination in step S302 or can display after a lapse of time until the technician (operator) moves to the front of the display unit 150.

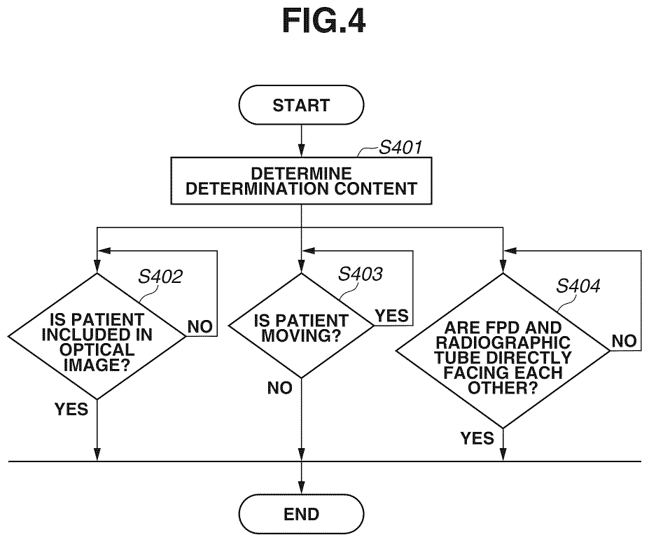

FIG. 4 illustrates a flowchart relating to the determination of the imaging preparation completion determination unit 105 in step S301.

In step S401, the imaging preparation completion determination unit 105 determines the determination content using the above-described determination table in FIG. 2. Since general radiography of a lower limb is performed, three condition determinations are used. In steps S402 to S404, determination is performed based on the determined determination content. In step S402, it is determined whether an examinee's body to be determined and analyzed is included. For example, it is determined whether a human body is included in the optical image by such image analysis as image recognition, temperature detection, and image difference detection. If no human body can be detected, the determination is repeated. At this time, the determination can be repeated as undeterminable in a case where not only the human body of the patient (subject) who is the imaging target but also a human body other than the patient, such as a radiology technician (operator) who performs the imaging preparation, is included in the optical image. In step S403, a body motion determination of an examinee's body (subject) is performed. For example, the body motion determination is performed by image analysis, such as the above-described human body detection and image difference detection. At this time, sensitivity is set such that fine alignment is not determined, assuming that a body motion is a large movement, such as the movement of a human body. If it is determined that there is a body motion (YES in step S403), the determination is repeated. In step S404, the FPD is detected, and it is determined whether the FPD directly faces the radiographic tube. For example, the FPD in optical image is detected by image recognition analysis, and the position and the angle of the FPD with respect to the radiographic tube (not illustrated) in the same optical image or to the optical imaging apparatus 140, if the optical imaging apparatus 140 is attached to or the radiographic tube, are analyzed, thereby determining whether the FPD directly faces thereto. When it is determined that the FPD does not directly face (NO in step S404), the determination is repeated. As a technique used for these determinations, an image recognition method using machine learning by the inference processing unit 106 can be used. In addition, a setting unit for adjustment can be provided in the display unit 150 so that the time interval or sensitivity of detection can be adjusted based on the imaging conditions, such as the portion to be imaged, or the age of the examinee. The determination in step S301 ends when the determinations in steps S402 to S404 are completed.

If it is determined that the preparation for radiation imaging has been completed via the above-described steps, an optical image is displayed on the display unit 150, and a technician (operator) performs an examination with reference to the optical image. If it is determined that the preparation for radiation imaging is not completed, no optical image is displayed on the display unit 150, and it is possible to recognize that the preparation for imaging is necessary (that the preparation is not completed). After the examination is completed, the optical image will be hidden. When the examination is performed again, this flow is repeated.

As described above, the optical image is displayed only at the timing at which the imaging preparation is completed and the examination is ready to be performed, and it is thereby possible to perform the examination while the privacy of the examinee is considered and the time and effort of the technician (operator) are reduced.

A second embodiment will now be described by focusing on differences with the above-described first embodiment.

As described below, the radiation imaging system according to the second embodiment has a configuration and operation in which no optical image is displayed in a case where a technician (operator) does not refer to the display unit 150 for imaging to better consider privacy.

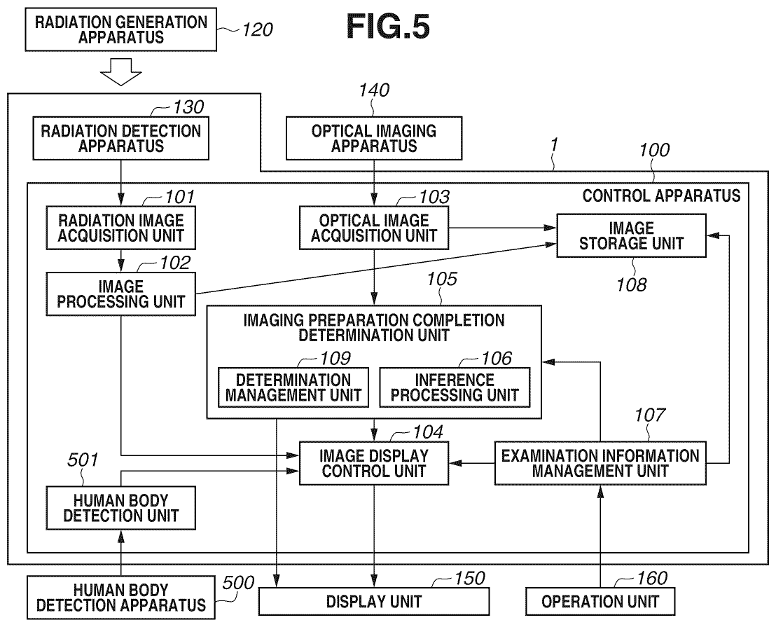

FIG. 5 illustrates an example of the configuration of the radiation imaging system according to the second embodiment. A human body detection apparatus 500 is located physically close to the display unit 150, and detects whether a person is standing in front of the display unit 150. It is also possible to detect whether a person is present in the vicinity of the display unit 150. The human body detection apparatus 500 can be an optical camera, a human detection sensor, a monitoring camera installed in a room, or the like. It is also preferable that an authentication function for determining, as a determination target, only a technician (operator) who operates radiation imaging is provided. The human body detection unit 501 acquires information (e.g., image data or an authentication result) about the technician (operator) from the human body detection apparatus 500, and manages the information. Thus, the human body detection unit 501 can also be hereinafter referred to as a third acquisition unit. The human body detection unit 501 can also have an authentication function for determining only a technician (operator) who operates radiation imaging. In this case, the human body detection unit 501 serving as the third acquisition unit acquires image data, identification information, and the like, about the technician (operator) from the human body detection apparatus 500, and performs technician (operator) authentication by determining whether the information matches information about the technician (operator) obtained in advance.

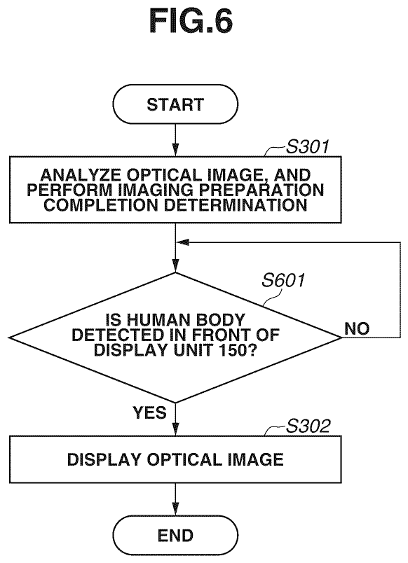

FIG. 6 illustrates a flowchart from the start of an examination to the display of a subject image according to the second embodiment. Here, an example of general radiography of a lower limb will be described.

After the imaging preparation completion determination in step S301, the human body detection unit 501 detects, in step S601, a human body in front of the display unit 150. If the human body detection unit 501 detects no such human body (NO in step S601), the processing proceeds to step S601 to repeat the detection. If the human body detection unit 501 detects such human body (YES in step S601), the processing proceeds to step S302. In step S302, the image display control unit 104 outputs an optical image to the display unit 150 thereby to display the optical image. For such detection, assuming, for example, a place where persons often pass in front of the display unit 150, a setting unit that adjusts a detection time or sensitivity can be provided in the display unit 150 to detect a presence of a human body for 3 seconds or more, for example.

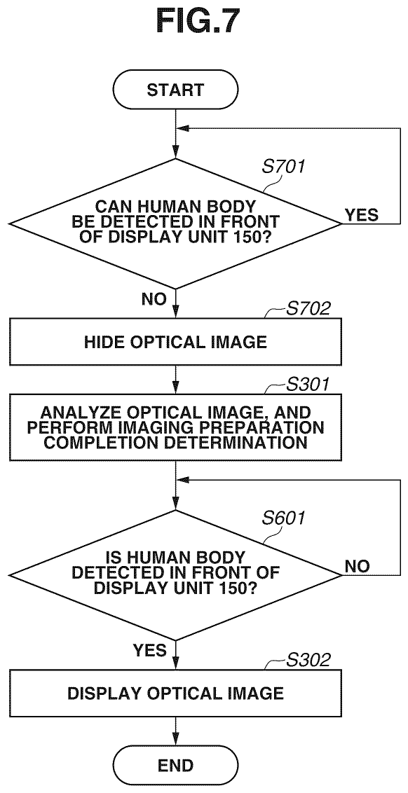

FIG. 7 illustrates a flowchart for performing re-determination and re-display after the optical image of step S302 in FIG. 6 is displayed on the display unit 150.

In step S701, the human body detection unit 501 detects a human body in front of the display unit 150. While such human body is being detected (YES in step S701), the detection is repeated while the optical image is displayed. If such human body cannot be detected any longer (NO in step S701), the process proceeds to step S702. The case where “such human body cannot be detected any longer” is assumed to be, for example, a case where the position adjustment of the radiographic tube or the posture adjustment of the examinee's body is required again and the technician (operator) moves away from the front of the display unit 150. In step S702, the optical image displayed on the display unit 150 is hidden. Thereafter, the imaging preparation completion determination is performed again from step S301.

According to the above-described procedures, the optical image is displayed only while the technician (operator) is checking the display of the optical image, thereby making it is possible to perform the examination in which privacy is better considered.

According to the present disclosure, imaging can be pursued while considering privacy and reducing the time and effort of the technician (operator).

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-007695, filed Jan. 22, 2024, which is hereby incorporated by reference herein in its entirety.

What is claimed is:

1. A radiation imaging control apparatus comprising:
a memory storing a program; and
at least one processor, that when executing the program, causes the radiation imaging control apparatus to:
acquire an optical image;
determine, based on the acquired optical image, a preparation status of radiation imaging; and
control output of the acquired optical image to a display apparatus,
wherein output of the acquired optical image to the display apparatus is based on a determination result on the preparation status of the radiation imaging.

2. The radiation imaging control apparatus according to claim 1, wherein, in a case where the determination result on the preparation status of the radiation imaging indicates completion of preparation, the acquired optical image is output to the display apparatus.

3. The radiation imaging control apparatus according to claim 1, wherein, in a case where the determination result on the preparation status of the radiation imaging indicates preparation incomplete, the acquired optical image is not output to the display apparatus.

4. The radiation imaging control apparatus according to claim 1, wherein the preparation status of the radiation imaging is determined based on whether there is a subject in the acquired optical image.

5. The radiation imaging control apparatus according to claim 1, wherein the preparation status of the radiation imaging is based on whether there is a movement of a subject in the acquired optical image.

6. The radiation imaging control apparatus according to claim 1, wherein the at least one processor is further configured to cause the radiation imaging control apparatus to acquire information regarding a radiation imaging protocol related to a subject, and
wherein the preparation status of the radiation imaging is based on the acquired information regarding the radiation imaging protocol.

7. The radiation imaging control apparatus according to claim 6, wherein the acquired information regarding the radiation imaging protocol is information regarding a portion to be imaged.

8. The radiation imaging control apparatus according to claim 1, wherein the at least one processor is further configured to cause the radiation imaging control apparatus to store a determination content and determination conditions.

9. The radiation imaging control apparatus according to claim 1, wherein the at least one processor is further configured to acquire information regarding an operator who operates the radiation imaging, and
wherein the preparation status of the radiation imaging is based on the acquired information regarding the operator.

10. The radiation imaging control apparatus according to claim 9, wherein the acquired information regarding the operator is information about whether the operator is in a vicinity of the display apparatus.

11. The radiation imaging control apparatus according to claim 10, wherein in a case where the acquired information regarding the operator is information indicating that the operator is not in the vicinity of the display apparatus, the at least one processor is further configured to control the radiation imaging control apparatus to not output the acquired optical image to the display apparatus.

12. A radiation imaging system comprising:
a radiation detection apparatus configured to generate a radiation image when irradiated with radiation; and
a radiation imaging control apparatus comprising:
a memory storing a program; and
at least one processor, that when executing the program, causes the radiation imaging control apparatus to:
acquire an optical image;
determine, based on the acquired optical image, a preparation status of radiation imaging; and
control output of the acquired optical image to a display apparatus,
wherein output of the acquired optical image to the display apparatus is based on a determination result on the preparation status of the radiation imaging.
